(19) United States
(12) Patent Application Publication
(10) Pub. No.: US 2021/0326753 A1
(43) Pub. Date: Oct. 21, 2021

(54) INFORMATION PROCESSING APPARATUS

(71) Applicant: FUJIFILM BUSINESS INNOVATION CORP, Tokyo (JP)

(72) Inventors: Hayahide YAMAGISHI, Kanagawa (JP); Seiya INAGI, Kanagawa (JP); Takafumi SUZUKI, Kanagawa (JP)

(73) Assignee: FUJIFILM BUSINESS INNOVATION CORP, Tokyo (JP)

(21) Appl. No.: 17/117,961

(22) Filed: Dec. 10, 2020

(30) Foreign Application Priority Data
Apr. 21, 2020 (JP) 2020-075501

(51) Int. Cl. G06N 20/00; G06F 40/279; G06N 5/04

(52) U.S. Cl. CPC G06N 20/00; G06N 5/04; G06F 40/279

(57) ABSTRACT

An information processing apparatus includes a processor configured to extract a reference example from first data and a negative example from second data, and perform a training process for training, using the reference example, a positive example corresponding to the reference example, the negative example, and strength of a relationship between the first data and the second data, a generator that generates a feature representation of input information.

### CROSS-REFERENCE TO RELATED APPLICATIONS

This application is based on and claims priority under 35 USC 119 from Japanese Patent Application No. 2020-075501 filed Apr. 21, 2020.

### BACKGROUND

### (i) Technical Field

The present disclosure relates to an information processing apparatus.

### (ii) Related Art

Jacob Devlin et al., “BERT: Pre-training of Deep Bidirectional Transformers for Language Understanding”, June 2019 (https://www.aclweb.org/anthology/N19-1423/) discloses a sentence vector generator employing a deep neural network (DNN). This example of the related art also discloses a trained model for general purposes, and a sentence vector generator specialized in a certain task can be easily created by separately preparing training data.

Liat Ein Dor et al., “Learning Thematic Similarity Metric Using Triplet Networks”, July 2018 (https://www.aclweb.org/anthology/P18-2009/) discloses a mechanisms that employs a DNN and that is used to train a sentence vector generator without essentially using training data. This mechanism employs a triplet network. In this mechanism, similar data (positive example) and different data (negative example) are prepared for a certain input, and the DNN is trained such that a vector corresponding to the input becomes closer to a vector corresponding to the positive example and farther from a vector corresponding to the negative example. If positive and negative examples can be automatically prepared with some assumptions, training data need not be manually collected.

The triplet network used in the method disclosed in “Learning Thematic Similarity Metric Using Triplet Networks” has originally been proposed in Erad Hoffer and Nir Ailon, “Deep Metric Learning Using Triplet Network”, December 2014 (https://arxiv.org/abs/1412.6622).

A word embedding training apparatus disclosed in Japanese Patent No. 6498095 improves, when vector representations of paragraphs, sentences, and words are to be learned, performance using results of training at each of levels for training at a lower level if data regarding the paragraphs, the sentences, and the words having a hierarchical structure is available as training data.

### SUMMARY

Aspects of non-limiting embodiments of the present disclosure relate to provision of a generator capable of generating feature representations that reflect differences between negative examples used in training of the generator better than a method in which all negative examples are handled uniformly.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to extract a reference example from first data and a negative example from second data, and perform a training process for training, using the reference example, a positive example corresponding to the reference example, the negative example, and strength of a relationship between the first data and the second data, a generator that generates a feature representation of input information.

### BRIEF DESCRIPTION OF THE DRAWINGS

An exemplary embodiment of the present disclosure will be described in detail based on the following figures, wherein:

FIG. 1 is a diagram illustrating an example of the functional configuration of a training system for training a sentence vector generator;

FIG. 2 is a diagram illustrating an example of data registered in a training database;

FIG. 3 is a diagram illustrating a process performed by the sentence vector generator and a vector distance measuring device;

FIGS. 4A and 4B are diagrams illustrating an effect produced by a method according to an exemplary embodiment;

FIG. 5 is a diagram illustrating an example of the functional configuration of the search system employing the trained sentence vector generator;

FIG. 6 is a diagram illustrating an example of data registered in a sentence vector database;

FIG. 7 is a diagram illustrating a search method used by the search system;

FIG. 8 is a diagram illustrating an example of a hierarchical structure of labels;

FIG. 9 is a diagram illustrating the functional configuration of a training system according to a modification;

FIG. 10 is a diagram illustrating an example of reference provision information; and

FIG. 11 is a diagram illustrating an example of the hardware configuration of a computer.

### DETAILED DESCRIPTION

An example of a system for training a sentence vector generator will be described hereinafter as an example of an information processing apparatus in the present disclosure.

The system in this example employs a triplet network, but includes an improvement from a conventional system of the same type.

A conventional training system employing a triplet network trains a sentence vector generator using positive examples similar to inputs (hereinafter referred to as “reference examples”) and negative examples that are not similar to the inputs. The conventional training system extracts sentences to be used as a reference example and a positive example from a certain part of a document and a sentence to be used as a negative example from another part of the document. Because the conventional training system handles negative examples as being on the same level insofar as the negative examples have been extracted from parts other than ones from which reference examples and positive examples have been extracted, differences between the parts from which the negative examples have been extracted are not reflected in training.

In an exemplary embodiment of the present disclosure, on the other hand, the training of the sentence vector generator reflects the strength of a relationship between a part from which a negative example has been extracted and a part from which a reference example has been extracted.

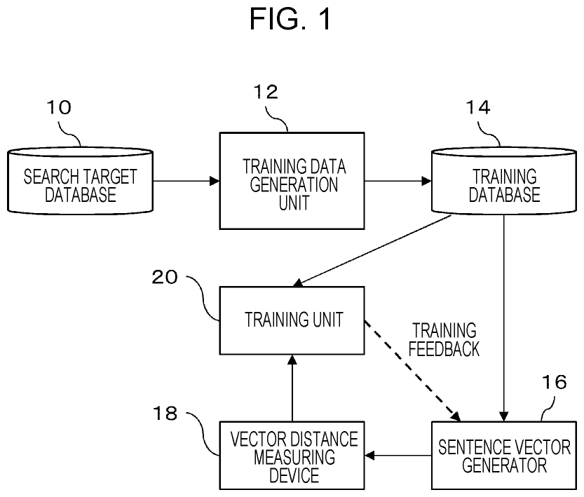

FIG. 1 illustrates an example of the functional configuration of a training system for training a sentence vector generator. This system includes a search target database 10, a training data generation unit 12, a training database 14, a sentence vector generator 16, a vector distance measuring device 18, and a training unit 20.

A large number of documents to be searched for are registered in the search target database 10. That is, in this example, training data is extracted from a set of documents to be searched for in a search system employing the sentence vector generator 16 to be trained in this training system. There are links between the documents registered in the search target database 10. Documents written in hypertext markup language (HTML) or extensible markup language (XML), for example, can include links to other documents. HTML documents, for example, are registered in the search target database 10.

The training data generation unit 12 extracts sentences to be used as reference examples, positive examples, and negative examples from the documents registered in the search target database 10 and generates a large number of sets of training data to be used to train the sentence vector generator 16.

In a process for generating training data, the training data generation unit 12 extracts a sentence to be used as a reference example from a document in the search target database 10 and then extracts a sentence to be used as a positive example of the reference example. The positive example is extracted from the same part of the set of documents registered in the search target database 10 as a part from which the reference example has been extracted. A “part” of a set of documents refers to a document element of a document included in the set, a document included in the set, or a subset defined in the set. A document element of a document is, for example, a chapter, a section, or the like included in the document. A subset is, for example, a genre at a time when the documents in the search target database 10 are classified into different genres. Whether a “part” refers to a document element, a document, or a subset is determined in advance. When a “part” refers to a document element, for example, the training data generation unit 12 extracts, as a positive example, a sentence other than a reference example in a document element from which the reference example has been extracted. When a “part” refers to a subset, the training data generation unit 12 extracts, as a positive example, a sentence other than a reference example in one of documents of a subset including a document from which the reference example has been extracted.

The training data generation unit 12 also extracts a sentence to be used as a negative example from a part of the set of documents registered in the search target database 10 different from the part from which the reference example has been extracted. Whereas a positive example is extracted from the same part as the reference example, a negative example is extracted from a part different from the part from which the reference example is extracted. The negative example is therefore “farther” from the reference example than the positive example is, that is, a relationship with the reference example is weaker.

The training data generation unit 12 also generates relationship information, which indicates the strength of a relationship between the document (referred to as a “first document”) from which the reference example has been extracted and a document (referred to as a “second document”) from which the negative example has been extracted. The first document is an example of first data, from which a reference example is extracted, and the second document is an example of second data, from which a negative example is extracted.

The relationship information represents the strength of the relationship with, for example, the route length of a shortest route connecting the first document to the second document with one or more links in a structure constructed by the links between the documents in the search target database 10. The route length of the shortest route is the number of links constituting the shortest route, and also called “hop count”. As the route length becomes smaller (i.e., as the hop count becomes smaller), the relationship between the first document and the second document becomes stronger. When there is no direct link from the first document to the second document and there are a link from the first document to a third document and a link from the third document to the second document, for example, the route length from the first document to the second document is 2. The route length of 2 indicates the second strongest relationship after a relationship indicated by a route length of 1. The training data generation unit 12 obtains the route length of the shortest route from the first document to the second document by examining a link structure of the documents in the search target database 10 and outputs the route length as the relationship information.

The training data generation unit 12 registers a combination of a reference example, a positive example, a negative example, and relationship information obtained in this manner to the training database 14 as a set of training data. The training data generation unit 12 generates a large number of sets of training data from the search target database 10 and accumulates the sets in the training database 14.

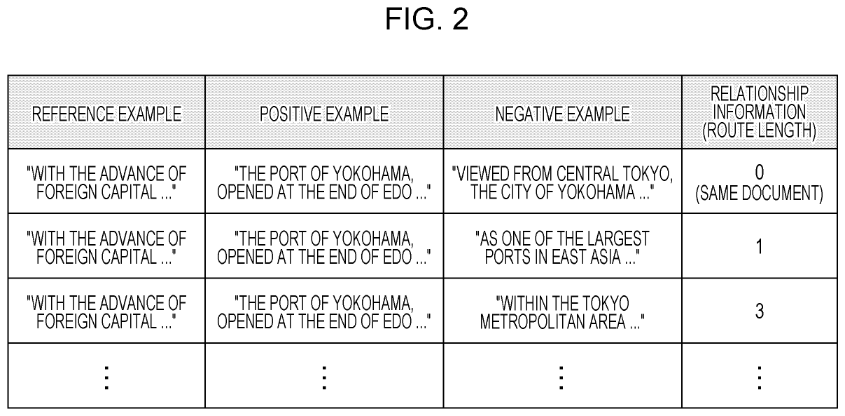

FIG. 2 illustrates the training data registered in the training database 14. The example illustrated in FIG. 2 is an example at a time when each positive example is extracted from the same document element as a corresponding reference example and a corresponding negative example is extracted from a different document element in the same document or from a different document. In the case of a top set of the training data illustrated in FIG. 2, a negative example has been extracted from a document from which a reference example has been extracted but from a document element different from one from which the reference example has been extracted. A value of relationship information, which is the route length, is 0. A second set of the training data, on the other hand, indicates that a negative example has been extracted from a document connected, through one link, to a document from which a reference example has been extracted.

FIG. 1 will be referred to again. The sentence vector generator 16 generates sentence vectors for a reference example, a positive example, and a negative example. A sentence vector is a vector that represents a feature of a sentence and is an example of feature representation for representing a feature of a sentence. The sentence vector generator 16 is achieved by a neural network such as a DNN. A known sentence vector generator typified by those disclosed in examples of the related art, or a sentence vector generator that will be developed in the future, may be used as the sentence vector generator 16.

The vector distance measuring device 18 measures, that is, calculates, distances between sentence vectors, namely a vector distance between a reference example and a positive example and a vector distance between the reference example and a negative example. A vector distance is a distance between sets of coordinates in a n-dimensional space (n is the number of dimensions of sentence vectors) represented by two sentence vectors, for example, but is not limited to this.

The training unit 20 calculates a loss on the basis of vector distances measured by the vector distance measuring device 18 and trains the neural network in the sentence vector generator 16 in accordance with the loss. An algorithm used for the training is not particularly limited.

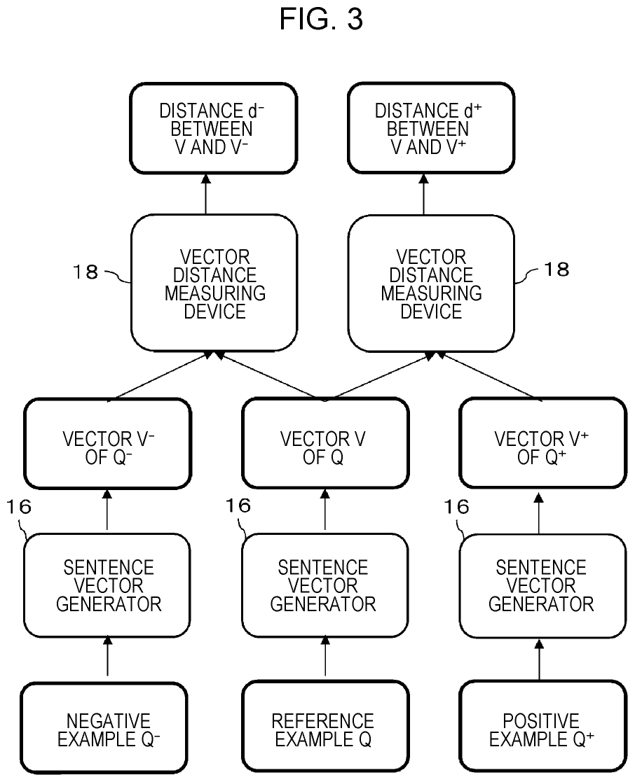

FIG. 3 sums up a process from the generation of sentence vectors to the measurement of vector distances. For example, a set of training data is obtained from the training database 14 and a reference example Q, a positive example Q⁺, and a negative example Q⁻ in the set of training data are input to the sentence vector generator 16 under control of the training unit 20. The sentence vector generator 16 generates a sentence vector V of the reference example Q, a sentence vector V⁺ of the positive example Q⁺, and a sentence vector V⁻ of the negative example Q⁻ from the input sentences. The vector distance measuring device 18 calculates a distance (referred to as a “positive example distance”) d⁺ between the sentence vector V of the reference example Q and the sentence vector V⁺ of the positive example Q⁺ and a distance (referred to as a “negative example distance”) d⁻ between the sentence vector V of the reference example Q and the sentence vector V⁻ of the negative example Q⁻.

The training unit 20 calculates a loss on the basis of the positive example distance d⁺ and the negative example distance d⁻. In a conventional method in which negative examples are not distinguished from one another, a loss L is calculated, for example, using the following loss function.

L=max(0,d⁺−d⁻+α) (1)

e.g., α=1

In expression (1), α is a positive constant margin to be provided between the positive example distance d⁺ and the negative example distance d⁻ and α=1 in this example. That is, the sentence vector generator 16 is trained using this loss function so that the sentence vector generator 16 generates sentence vectors with which negative examples are farther from reference examples than positive examples are by a distance of 1 or more.

In the present exemplary embodiment, on the other hand, a margin to be provided between the positive example distance d⁺ and the negative example distance d⁻ is varied in accordance with relationship information, that is, the strength of a relationship between a part from which a reference example has been extracted and a part from which a negative example has been extracted. That is, as the relationship becomes weaker, the margin becomes larger. In a specific example, for example, the following loss function is used.

$$L = max ( 0 , {d}^{+} - {d}^{-} + m ( {Q}^{-} ) ) \\ m ( {Q}^{-} ) = \{ \begin{matrix}α \text{:} Sentences in documents whose route length is 0 \\ 2 α \text{:} Sentences in documents whose route length is 1 \\ 3 α \text{:} Sentences in documents whose route length is \\ greater than or equal to 2\end{matrix} \qquad ( 2 )$$

In expression (2), α is a positive constant. Three stages, namely 0, 1, and 2 or more, are provided for the relationship information illustrated in FIG. 2, that is, the route length, and the margin increases as the relationship information goes through the stages, that is, the relationship becomes weaker. The margin is a minimum distance by which a sentence vector of a negative example is to be away from a sentence vector of a reference example. In the example of expression (2), a case where there is no route connecting a part from which a reference example has been extracted to a part from which a negative example has been extracted through one or more links corresponds to the stage at which the route length is 2 or more.

The training unit 20 calculates the loss L using a loss function, such as expression (2), that takes into consideration the strength of the relationship between a part from which a reference example has been extracted and a part from which a negative example has been extracted. The training unit 20 then trains the sentence vector generator 16 by feeding back the obtained loss L.

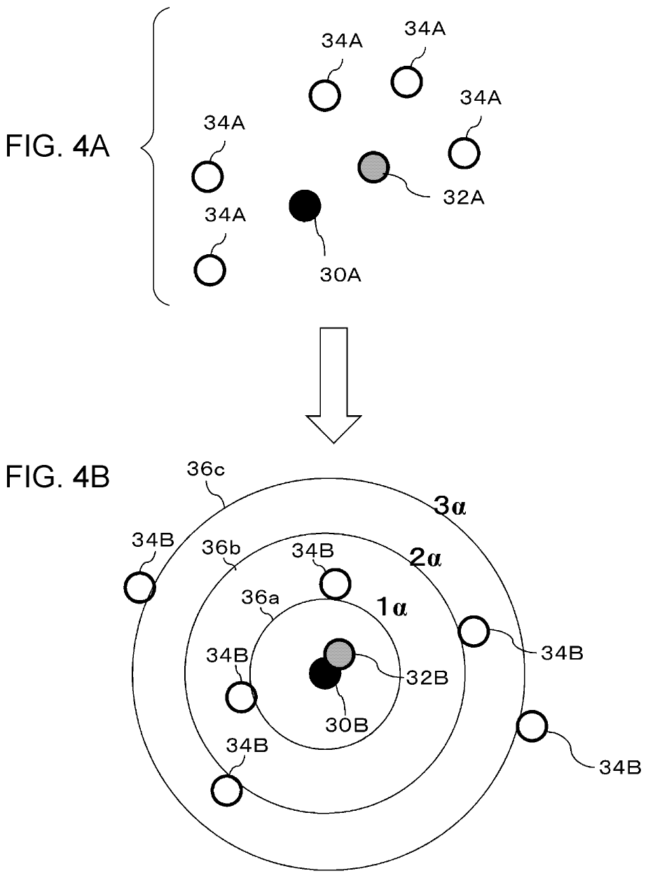

FIGS. 4A and 4B schematically illustrate an effect of training at a time when the sentence vector generator 16 is trained, using expression (2) as a loss function, with a large number of sets of training data in which a fixed reference example, a fixed positive example, and various negative examples are used.

FIG. 4A schematically illustrates distribution of sentence vectors generated by the sentence vector generator 16 before training. It is assumed that, before the training, a sentence vector 30A of a reference example, a sentence vector 32A of a positive example, and sentence vectors 34A of negative examples generated by the sentence vector generator 16 do not have a particular structure.

Sentence vectors generated by the sentence vector generator 16 trained using a large number of sets of training data in which a fixed reference example, a fixed positive example, and various negative examples are used, on the other hand, exhibits, for example, distribution illustrated in FIG. 4B. In this distribution, if a sentence vector 30B of the reference example is set at an origin, a sentence vector 32B of the positive example is located near the origin, that is, within a distance of 1α from the origin. Each of sentence vectors 34B of the negative examples, however, is located within a distance of more than or equal to 1α but less than 2α from the origin, within a distance of more than or equal to 2α but less than 3α, or 3α or longer away from the origin, depending on whether the route length from a document from which the reference example has been extracted to a document from which the negative example has been extracted is 0, 1, or 2 or more, respectively. In the training employing expression (2), sentence vectors generated from negative examples thus have a distribution having a structure in which the sentence vectors are classified into different stages depending on the size of the margin.

The example illustrated in FIGS. 4A and 4B is an example at a time when a reference example and a positive example are fixed for the sake of description. In actual training, however, each of sentences in a large number of sets of training data might be used as a reference example and might be used as a positive example or a negative example. In addition, relationship information (e.g., route length) when a certain sentence is used as a negative example changes if a reference example corresponding to the negative example changes. Distribution of sentence vectors generated by a fully trained sentence vector generator 16, therefore, will be one obtained by combining together distributions similar to that illustrated in FIG. 4B at a time when all sentences in the documents in the search target database 10 have been used as a reference example.

If a sufficiently large number of sets of training data are prepared from the search target database 10, each of sentences included in the individual documents in the search target database 10 forms combinations with various other sentences in the large number of sets of training data as a reference example, a positive example, and a negative example. If the sentence vector generator 16 is trained using a large number of sets of training data, therefore, sentence vectors that reflect not only relationships between a reference example, a positive example, and a negative example but also differences in relationship information between negative examples in relation to reference examples.

Expression (2) is just an example. Any loss function may be used in the present exemplary embodiment insofar as the margin increases as a relationship between a part from which a reference example has been extracted and a part which a negative example has been extracted becomes weaker, that is, as a distance between the part from which the reference example has been extracted and the part from which the negative example has been extracted.

In the present exemplary embodiment, the sentence vector generator 16 is thus trained such that a sentence vector of a negative example becomes farther from a sentence vector of a reference example as a relationship between a document from which the reference example has been extracted and a document from which the negative example has been extracted becomes lower in strength (i.e., weaker). Here, the situation “such that a sentence vector of a negative example becomes farther from a sentence vector of a reference example as a relationship between a document from which the reference example has been extracted and a document from which the negative example has been extracted becomes lower in strength (i.e., weaker)” holds true between negative examples with which the strength of relationships is different from one another but other conditions (e.g., a distance between a sentence vector of a negative example and a sentence vector of a reference example) are the same.

Although the stages of the relationship information, that is, the route length, are 0, 1, and 2 or more in expression (2), this is just an example. The number of stages of the relationship information for negative examples may be any value larger than or equal to 2. The number of stages may be appropriately determined in accordance with a link structure of the documents in the search target database 10, purposes of searches, or the like.

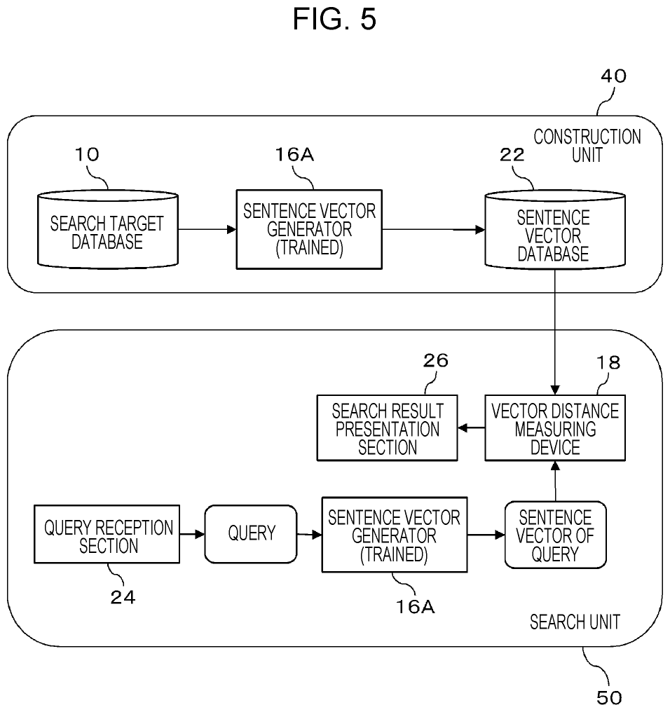

FIG. 5 illustrates an example of a search system employing a sentence vector generator 16A fully trained by the above-described training system. In FIG. 5, components having the same functions as those of the training system illustrated in FIG. 1 are given the same reference numerals as in FIG. 1.

The search system illustrated in FIG. 5 includes a construction unit 40 that constructs a sentence vector database 22 from the search target database 10 and a search unit 50 that searches the sentence vector database 22.

The construction unit 40 includes the search target database 10, the trained sentence vector generator 16A, and the sentence vector database 22. The sentence vector generator 16A extracts documents from the search target database 10 one by one, extracts sentences from the extracted documents one by one, and generates sentence vectors of the obtained sentences. The sentence vector generator 16A registers the generated sentence vectors to the sentence vector database 22 while associating the sentence vectors with, for example, the corresponding sentences and information (hereinafter referred to as “source information”) regarding parts from which the corresponding sentences have been extracted.

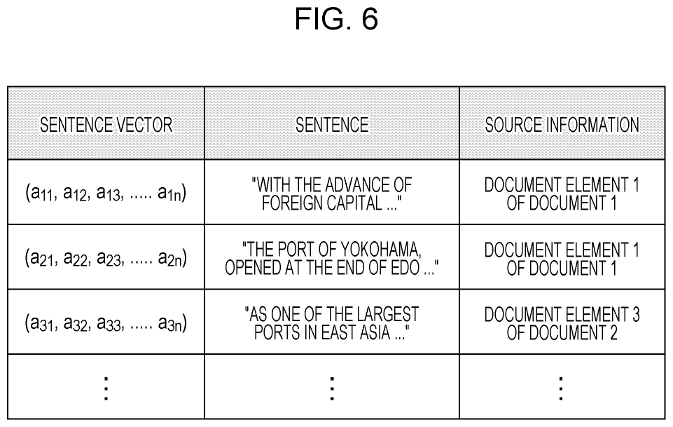

The sentence vector database 22 holds information regarding the sentence vectors registered by the sentence vector generator 16A. FIG. 6 illustrates data content held by the sentence vector database 22. As illustrated in FIG. 6, the sentence vector database 22 includes, for each of the sentences in the search target database 10, a sentence vector corresponding to the sentence, the sentence itself, and source information regarding the sentence. In FIG. 6, the source information includes pairs of identification information regarding a document from which a sentence has been extracted and identification information regarding a document element of the document in which the sentence was included.

The search unit 50 includes a query reception section 24, the sentence vector generator 16A, the vector distance measuring device 18, and a search result presentation section 26.

The query reception section 24 receives, from a user, a sentence to be used as a query. The sentence vector generator 16A generates a sentence vector of the query. The sentence vector generator 16A may be that included in the construction unit 40.

The vector distance measuring device 18 calculates, for each of the sentence vectors in the sentence vector database 22, a vector distance between the sentence vector and the sentence vector of the query.

The search result presentation section 26 searches, on the basis of a result of the calculation performed by the vector distance measuring device 18, the sentence vectors of the sentences in the sentence vector database 22 for a sentence vector similar to that of the query and presents information regarding the found sentence vector to the user.

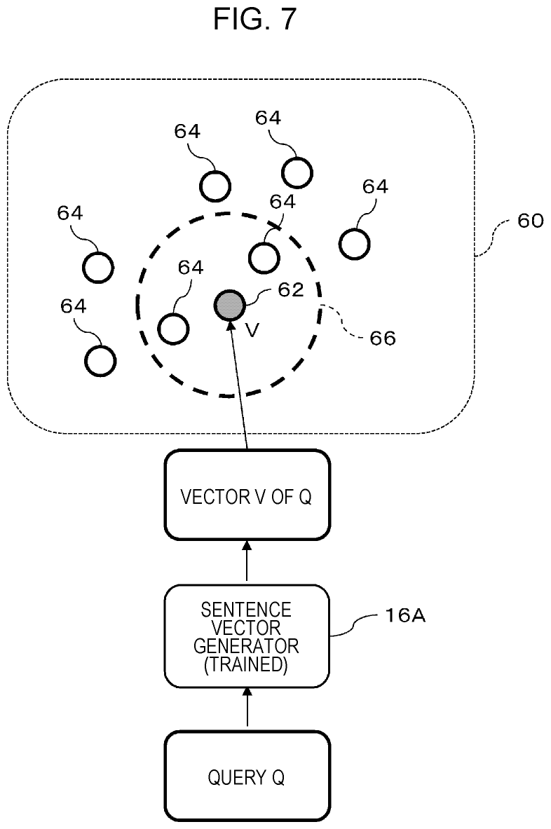

A concept of the search will be described with reference to FIG. 7. In FIG. 7, a sentence vector space 60 is a space where sentence vectors 64 generated by the trained sentence vector generator 16A from the sentences in the documents in the search target database 10 are mapped. When the user inputs a query, the sentence vector generator 16A generates a sentence vector V (62) corresponding to the query. The sentence vector 62 is also mapped in the sentence vector space 60. The vector distance measuring device 18 calculates a distance between the sentence vector 62 of the query and each of the sentence vectors 64 of the sentences in the documents in the search target database 10. A broken line 66 illustrated in FIG. 7 represents an n-dimensional hypersphere (n is the number of dimensions of sentence vectors) defined by a group of dots away from the query (i.e., the sentence vector 62) by a certain distance. In this example, the inside of the hypersphere is a range within which it is determined that a sentence vector is similar to that of the query (i.e., the sentence vector 62). The search result presentation section 26 searches the sentence vector space 60 for sentence vectors mapped within the hypersphere whose center is the query (i.e., the sentence vector 62), that is, sentence vectors within the certain distance from the sentence vector of the query.

The search result presentation section 26 presents a list of information regarding the found sentence vectors to the user by, for example, displaying the list on a screen. On the list, for example, the found sentence vectors are arranged in ascending order of distance to the sentence vector of the query. The list may also include sentences corresponding to the found sentence vectors. The list may also include document elements or documents from which sentences corresponding to the found sentence vectors have been extracted or links to the document elements or the documents. The document elements or the documents from which the sentences corresponding to the found sentence vectors have been extracted may be obtained from source information (refer to FIG. 6) corresponding to the sentences.

As described above, in the present exemplary embodiment, negative examples are classified in accordance with the strength of relationships (i.e., distances) between documents from which the negative examples have been extracted and documents from which reference examples have been extracted, and the margin employed in the training based on a triplet network reflects the strength of the relationships. As a result, differences are caused between the negative examples, and the sentence vector generator 16 is trained in such a way as to generate sentence vectors that reflect the differences. When the sentence vector generator 16A trained in this manner is used, sentence vectors that reflect differences between sentences better than a sentence vector generator trained in a conventional manner, in which negative examples are not provided with such differences, is obtained.

Although the training system (refer to FIG. 1) for training the sentence vector generator 16 and the search system (refer to FIG. 2) for making searches using the trained sentence vector generator 16A have been described, these systems may be integrated into a single computer.

In the above exemplary embodiment, the route length of a route including one or more links connecting a document from which a reference example has been extracted to a document from which a negative example has been extracted is used as an index value indicating the strength of a relationship between the two documents. This, however, is just an example. More generally, when the documents in the search target database 10 form a structure based on relationships therebetween (hereinafter referred to as a “relationship structure”), a distance between the two documents in the relationship structure is used as an index value indicating the strength of the relationship between the two documents.

Examples of the relationship structure of documents include the above-described link structure, which is based on links between documents, and a reference relationship, in which relationships between documents can be identified from information regarding references included in fields of a list of references in the documents.

As an index value indicating a distance between two documents in the relationship structure, for example, the number of relationships included in a route (e.g., a shortest route) connecting the two documents to each other with one or more relationships in the relationship structure may be used, as in the case of the above-described route length. If strength is set for each of relationships included in the relationship structure, a distance between documents may reflect the strength of each of relationships in a route between the documents such that the distance becomes longer as the strength becomes lower (i.e., the relationship becomes weaker). If relationships have types and the strength of a relationship varies depending on the type of relationship, a distance between documents may reflect a type of each of relationships in a route between the documents.

In the above example, the training of the sentence vector generator 16 reflects distances between documents in a relationship structure of the documents. In another example, when relationships between labels attached to documents form a structure, the training of the sentence vector generator 16 may reflect distances between the labels in the relationship structure.

A label is information indicating a feature, a classification, or the like of a document viewed from a certain aspect and, for example, extracted from content of the document or attribute information regarding the document or explicitly attached by the user to the document. A date and a year of creation, a creator, a submission destination, a date and a year of disclosure, a date and a year of issuance, a theme, or a category of a subject of a document, for example, can be used as a label of the document. When a document is a contract, a contract amount, a contract year, a contract type, and a model of a machine for which a contract has been made are examples of a label of the document, and when a document is a manual for an apparatus, a category and a model of the apparatus are examples of a label of the document.

A relationship structure of labels is, for example, a set of relationships between two labels. When themes of documents are used as labels of the documents, for example, similarity, inclusion, and the like between themes are examples of the relationships between the labels. When creators of documents are used as labels of the documents, friendship and relationships between roles in organizations to which the creators belong, for example, may be used as labels of the documents. When models of apparatuses covered by manuals are used as labels of the documents, relationships between models, that is, relationships between preceding models and succeeding models and similarity between models are examples of the relationships between the labels. In addition, information regarding relationships between concepts included in a general concept dictionary such as WordNet or Wikidata (registered trademark), a glossary created by a certain company for in-house use, an ontology in a certain field, or the like may be used as a relationship structure of labels.

A relationship structure of labels can be represented by a graph in which the labels correspond to nodes and relationships between the labels correspond to edges, for example, and used as a graph database.

If there is a route connecting two labels to each other with one or more relationships in a relationship structure of labels, the number of relationships (i.e., the route length) included in the route may be used as an index value indicating the strength of the relationship between the labels. If there is an index value (e.g., a difference in a contract amount) indicating the strength of a relationship between labels, a distance between the labels may reflect the strength of individual relationships in a route between the labels. The distance between the labels may also reflect types of individual relationships in the route between the labels.

In an example in which a relationship structure of labels is used, the margin m(Q⁻) used in expression (2) may be determined in accordance with, for example, a distance in the relationship structure of a label of a document from which a reference example has been extracted and a label of a document from which a negative example has been extracted.

Labels might form a hierarchical structure when, for example, there are hierarchical relationships between concepts indicated by labels.

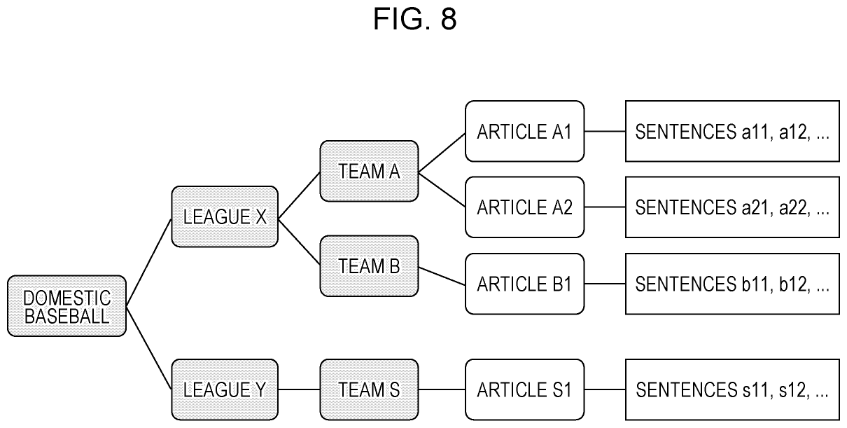

FIG. 8 illustrates an example of labels that can be attached to newspaper articles regarding Japanese professional baseball and hierarchical relationships between the labels. The newspaper articles include articles regarding individual teams such as team A and team B. Labels indicating the teams, such as team A and team B, covered by the articles, therefore, are attached to the articles. Because the teams belong to league X or league Y, labels indicating leagues to which the teams covered by the articles belong are also attached to the articles. In addition, because league X and league Y belong to a Japanese professional baseball organization, a label indicating “domestic baseball” is also attached to the articles. For example, three labels, namely “team A”, “league X”, and “domestic baseball”, can be attached to articles A1 and A2 that cover team A. Each article includes one or more sentences, that is, for example, article A1 includes sentences a11, a12, and so on.

In addition, a hierarchical structure of folders in a file system for saving articles regarding Japanese professional baseball may be formed in accordance with the hierarchical structure of the labels illustrated in FIG. 8. In this case, a name of a folder storing each of the articles and names of folders at levels higher than a level at which the folder storing the article in the folder hierarchical structure may be used as labels attached to the article.

A distance between two labels in a hierarchical structure is determined, for example, on the basis of the length of a route, which is one or more hierarchical relationships (i.e., parent-child relationships), in the hierarchical structure from one of the labels to the other label. The length of a route is expressed, for example, by the number of hierarchical relationships included in the route. In the case of a route from the label “team A” to the label “team B”, the number of hierarchical relationships is two, namely one upward relationship and one downward relationship. In the case of the label “team A” to the label “league Y”, the number of hierarchical relationships is three, namely two upward relationships and one downward relationship.

If two labels are at the same level in a hierarchical structure, a distance between the labels may be the number of levels that the two labels need to travel up in the hierarchical structure to reach a superior label to which the two labels belong in common, instead.

The training unit 20 trains the sentence vector generator 16 such that a distance between a sentence vector of a reference example and a sentence vector of a negative example becomes longer as a distance between a sentence used as the reference example and a sentence used as the negative example becomes longer in a hierarchical structure. Such training may be achieved, for example, by increasing the margin included in the loss function as a distance between a label attached to a reference example and a label attached to a negative example becomes longer in a hierarchical structure.

In the example in which the hierarchical structure of the labels is used, the training data generation unit 12 extracts a sentence to be used as a positive example from a document to which the same label (referred to as a “target label”) as one attached to a document from which a sentence used as a reference example has been extracted is attached. The training data generation unit 12 extracts a sentence to be used as a negative example from a document at the same level as the target label in the hierarchical structure of the labels but to which a label different from the target label is attached. The level of the target label is determined in advance (e.g., the user specifies the level). If the level of the target label is a level of the team names and a reference example has been extracted from article A1 in the example illustrated in FIG. 8, for example, a positive example is extracted from article A1, or article A2, which has the same team name label “team A” as article A1. A negative example, on the other hand, is extracted from article B1 or S1, which has a label “team B” or “team S” at the same level as “team A”. In this case, a subset including articles A1 and A2, which have the label “team A” in common, is a part of the set of all the documents in the search target database 10, and it is considered that a positive example is extracted from the same “part” as a reference example and a negative example is extracted from a “part” different from that from which the reference example is extracted.

Although a case where labels form a hierarchical structure has been described, the same holds when documents form a hierarchical structure.

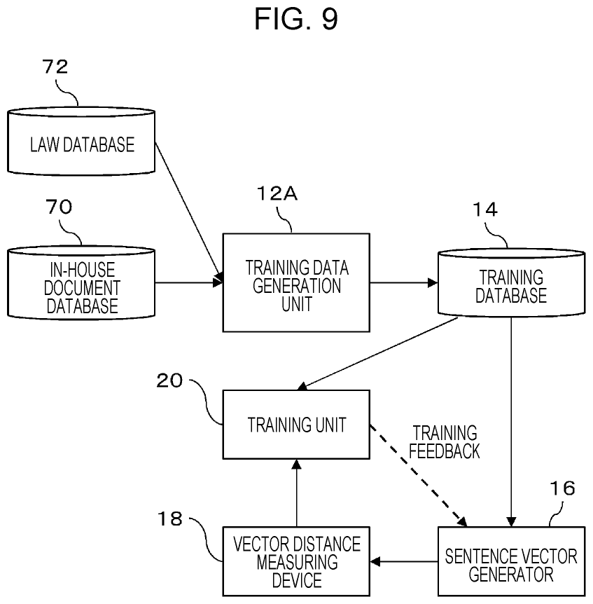

Next, a modification of the above exemplary embodiment will be described with reference to FIGS. 9 to 11. In the above exemplary embodiment, an example of a case where documents in a set of documents to be searched for form a structure has been described. A method employed in the above exemplary embodiment, however, may be used in other cases.

In the present modification, a case is assumed where documents in a first set of documents to be searched for each refer to a document in a second set of documents and the documents in the second set form a structure. In the present modification, reference examples, positive examples, and negative examples are selected from the first set of documents, but information used in training indicating differences between the negative examples in terms of distances to the corresponding reference examples is obtained from a structure of documents included in the second set referred to by the reference examples and the negative examples.

FIG. 9 illustrates an example of a training system in the present modification. In FIG. 9, components having the same functions as those of the components of the training system illustrated in FIG. 1 are given the same reference numerals.

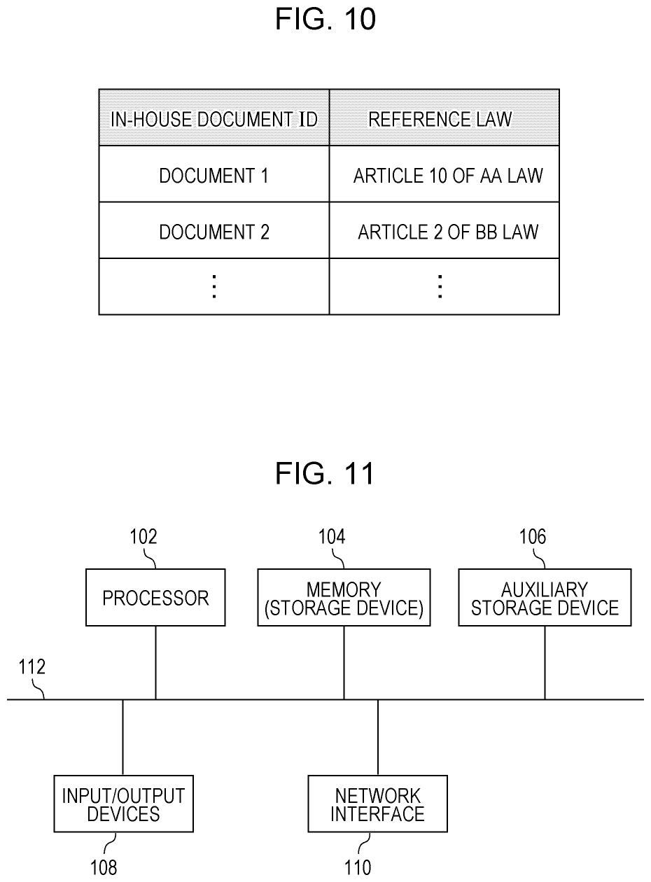

An in-house document database 70 stores in-house documents of a certain company and corresponds to the search target database 10 illustrated in the example illustrated in FIG. 1. In this example, the in-house documents stored in the in-house document database 70 and sentences included in the in-house documents are to be searched for. The in-house documents are created in conformity to various laws relating to corporate activities. Each of the in-house documents includes a provision in a law referred to thereby. The in-house document database 70 also stores reference provision information (refer to FIG. 10) indicating the provision of the law referred to by each of the in-house documents. The reference provision information illustrated in FIG. 10 indicates, for each of the in-house documents, identification information regarding the in-house document (i.e., a document ID) and identification information regarding the provision of the law referred to by the in-house document (a pair of a name of the law and a provision number in the example illustrated in FIG. 10).

A law database 72 stores information regarding various laws including the laws referred to by the in-house documents in the in-house document database 70. A provision in each of the laws stored in the law database 72 might relate to another provision in the same law or a provision in a law. For example, a number of another provision in the same law might be written in a provision, or a name of another law and a provision number might be written in a provision. Information indicating a relationship between provisions described in one of the provisions may be extracted by analyzing text of the laws in advance or on demand.

The training data generation unit 12A extracts reference examples, positive examples, and negative examples from the in-house document database 70. The extraction performed by the training data generation unit 12A is the same as that performed by the training data generation unit 12 illustrated in FIG. 1. That is, sentences to be used as a reference example and a positive example are extracted from the same “part” of the set of documents in the in-house document database 70, and a sentence corresponding to a negative example is extracted from a different “part”.

In addition, the training data generation unit 12A obtains relationship information (refer to FIG. 2) indicating a relationship between a reference example and a negative example in the following manner. That is, the training data generation unit 12A identifies, in the reference provision information (refer to FIG. 10), provisions of laws referred to by the reference example and the negative example and obtains, from the information stored in the law database 72, relationship information indicating a relationship between the provision of the law referred to by the reference example and the provision of the law referred to by the negative example. The relationship information indicating a relationship between the provision of the law referred to by the reference example and the provision of the law referred to by the negative example is, for example, a value based on the length of a route connecting the two provisions to each other with one or more relationships, that is, the number of relationships included in the route, in a structure formed by relationships between provisions of laws.

The training data generation unit 12A registers the extracted reference example, positive example, and negative example and the generated relationship information to the training database 14. A large number of sets of training data generated in this manner are accumulated in the training database 14.

A training process performed by the sentence vector generator 16 using the training data accumulated in the training database 14 and a search process performed by the trained sentence vector generator 16A may be the same as those according to the above-described exemplary embodiment.

In this example, a provision of a law referred to by a reference example corresponds to first association data associated with first data, and a provision of a law referred to by a negative example corresponds to second association data associated with second data.

The training system for training the sentence vector generator 16 and the search system employing the trained sentence vector generator 16A described above are constructed, for example, using a general-purpose computer. This computer has, as illustrated in FIG. 11, for example, a circuit configuration in which a processor 102, a memory (storage device) 104 such as a random-access memory (RAM), a controller that controls an auxiliary storage device 106, which is a nonvolatile storage device such as a flash memory, a solid-state drive (SSD), or a hard disk drive (HDD), an interface with various input/output devices 108, a network interface 110 that performs control for connection to a network such as a local area network (LAN), and the like are connected, as hardware, to one another by a data transmission path such as a bus 112. Although all the components, namely the processor 102 to the network interface 110, are simply connected to the same bus 112 in the example illustrated in FIG. 10, this is just an example. Alternatively, a hierarchical structure may be employed in which some of the components (e.g., some components including the processor 102) are integrated on a single chip as a system on a chip (SoC), for example, and the rest of the components are connected to an external bus to which the chip is connected.

In the embodiment above, the term “processor 102” refers to hardware in a broad sense. Examples of the processor include general processors (e.g., CPU: Central Processing Unit) and dedicated processors (e.g., GPU: Graphics Processing Unit, ASIC: Application Integrated Circuit, FPGA: Field Programmable Gate Array, and programmable logic device).

In the embodiment above, the term “processor 102” is broad enough to encompass one processor or plural processors in collaboration which are located physically apart from each other but may work cooperatively. The order of operations of the processor 102 is not limited to one described in the embodiment above, and may be changed.

Some or all of the components of each of the above-described systems may be achieved as hardware circuits.

In the above description, the systems that train and employ the sentence vector generator 16 have been taken as an example. The sentence vector generator 16 generates sentence vectors that represents features of sentences with vectors. Methods used in the above exemplary embodiment and the modification, however, may be used for data other than sentences, which is, for example, text data including sentences, images, moving images, sounds, multimedia data, or the like. Features of such data need not be represented by vectors and may be represented in another format. The method according to the above exemplary embodiment can thus be used to train and employ a common generator that generates representations of features of data.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
extract a reference example from first data and a negative example from second data, and
perform a training process for training, using the reference example, a positive example corresponding to the reference example, the negative example, and strength of a relationship between the first data and the second data, a generator that generates a feature representation of input information.

2. The information processing apparatus according to claim 1,
wherein the training process is a process in which the generator is caused to generate feature representations of the reference example, the positive example, and the negative example and the generator is trained using a distance between the feature representations of the reference example and the positive example, a distance between the feature representations of the reference example and the negative example, and the strength of the relationship between the first data and the second data.

3. The information processing apparatus according to claim 2,
wherein, in the training process, the generator is trained such that the distance between the feature representations of the reference example and the negative example becomes longer as the relationship between the first data and the second data becomes weaker.

4. The information processing apparatus according to claim 3,
wherein the strength of the relationship between the first data and the second data has a plurality of stages, and
wherein, in the training process, the generator is trained such that, in a case where the strength of the relationship between the first data and the second data is at a first stage and in a case where the strength of the relationship between the first data and the second data is at a second stage, the first and second stages being among the plurality of stages, the distance between the feature representations of the reference example and the negative example differs by a value according to a difference between the first stage and the second stage.

5. The information processing apparatus according to claim 1,
the strength of the relationship between the first data and the second data is obtained on a basis of a distance between the first data and the second data in a structure corresponding to a plurality of pieces of data.

6. The information processing apparatus according to claim 2,
the strength of the relationship between the first data and the second data is obtained on a basis of a distance between the first data and the second data in a structure corresponding to a plurality of pieces of data.

7. The information processing apparatus according to claim 3,
the strength of the relationship between the first data and the second data is obtained on a basis of a distance between the first data and the second data in a structure corresponding to a plurality of pieces of data.

8. The information processing apparatus according to claim 4,
the strength of the relationship between the first data and the second data is obtained on a basis of a distance between the first data and the second data in a structure corresponding to a plurality of pieces of data.

9. The information processing apparatus according to claim 5,
wherein the structure is formed on a basis of relationships between the plurality of pieces of data, and
wherein the distance in the structure between the first data and the second data is obtained on a basis of a relationship included in a route connecting the first data and the second data to each other in the structure.

10. The information processing apparatus according to claim 6,
wherein the structure is formed on a basis of relationships between the plurality of pieces of data, and
wherein the distance in the structure between the first data and the second data is obtained on a basis of a relationship included in a route connecting the first data and the second data to each other in the structure.

11. The information processing apparatus according to claim 7,
wherein the structure is formed on a basis of relationships between the plurality of pieces of data, and
wherein the distance in the structure between the first data and the second data is obtained on a basis of a relationship included in a route connecting the first data and the second data to each other in the structure.

12. The information processing apparatus according to claim 8,
wherein the structure is formed on a basis of relationships between the plurality of pieces of data, and
wherein the distance in the structure between the first data and the second data is obtained on a basis of a relationship included in a route connecting the first data and the second data to each other in the structure.

13. The information processing apparatus according to claim 5,
wherein a label is attached to each of the plurality of pieces of data,
wherein the structure is formed on a basis of relationships between the labels, and
wherein the distance in the structure between the first data and the second data is obtained on a basis of a relationship included in a route connecting a first label attached to the first data and a second label attached to the second data to each other in the structure.

14. The information processing apparatus according to claim 9,
wherein the distance in the structure between the first data and the second data is obtained on a basis of a number of relationships included in the route.

15. The information processing apparatus according to claim 5,
wherein the structure is a hierarchical structure of the plurality of pieces of data, and
wherein the distance in the structure between the first data and the second data is obtained on a basis of a distance in the hierarchical structure between the first data and the second data.

16. The information processing apparatus according to claim 5,
wherein a label is attached to each of the plurality of pieces of data,
wherein the structure is a hierarchical structure of the labels, and
wherein the distance in the structure between the first data and the second data is obtained on a basis of a distance in the hierarchical structure between a first label attached to the first data and a second label attached to the second data.

17. The information processing apparatus according to claim 16,
wherein the positive example is extracted from third data to which, as with the first data, the first label is attached and the second label is at a same level as the first label in the hierarchical structure.

18. The information processing apparatus according to claim 1,
wherein the strength of the relationship between the first data and the second data is obtained on a basis of strength of a relationship between first association data associated with the first data and second association data associated with the second data.

19. The information processing apparatus according to claim 1,
wherein the processor is also configured to
input query data to the generator subjected to the training process, and
search for data having a feature representation similar to a feature representation of the query data output from the generator in response to the input query data.

20. An information processing apparatus comprising:
a processor configured to
input query data to a generator that generates a feature representation of input information, and
search for data having a feature representation similar to a feature representation of the query data output from the generator in response to the input query data,
wherein the generator has been trained for generation of the feature representation using a reference example extracted from first data, a positive example corresponding to the reference example, a negative example extracted from second data, and strength of a relationship between the first data and the second data.
